(19) United States
(12) Patent Application Publication
(10) Pub. No.: US 2020/0260718 A1
(43) Pub. Date: Aug. 20, 2020

(54) EXPANDABLE TREESTAND

(71) Applicant: Todd A. Robbins, Brooklyn, IA (US)

(72) Inventor: Todd A. Robbins, Brooklyn, IA (US)

(21) Appl. No.: 16/280,835

(22) Filed: Feb. 20, 2019

(51) Int. Cl. A01M 31/02

(52) U.S. Cl. CPC A01M 31/02

(57) ABSTRACT

A treestand for supporting a user between two tree trunks or limbs of a tree above the ground, including first and second telescopically interconnected sections. A threaded bolt is rotatably connected to one of the frame sections and limited against longitudinal movement. The opposite end of the bolt is connected to a nut fixedly attached to the other frame section whereby rotation of the bolt will contract or expand the frame sections relative to each other and thus permit the outer ends of the frame sections to lockingly engage the spaced-apart tree trunks.

### BACKGROUND OF THE INVENTION

It is common for deer hunters to use a treestand mounted between two limbs of a tree when hunting deer. The problem with a conventional treestand is that it cannot forcibly expand the frame sections into reliable locking engagement with the tree limbs. A conventional practice is for the treestand to simply be dropped between the spaced-apart tree limbs thereby putting the opposite ends of the treestand in engagement with the tree limbs. The problem with this practice is that the opposite ends of the treestand may not be sufficiently locked into engagement with the tree limbs to prevent with certainty the treestand from falling out of engagement and thus endangering the person standing on it.

### BRIEF DESCRIPTION OF THE DRAWINGS

FIG. 1 is a perspective view of the expandable treestand embodying the present invention disposed between two limbs of a tree.

FIG. 2A is a perspective top view of the expandable treestand;

FIG. 2B is a perspective top view of the expandable treestand including a top clover grate;

FIG. 3A is a top plan view of the expandable treestand without the clover grate;

FIG. 3B is a top plan view of the expandable treestand with the clover grate;

FIG. 4A is a bottom view of the expandable treestand without the clover grate;

FIG. 4B is a bottom view of the expandable treestand with the clover grate;

FIG. 5 is a top view of the expandable treestand in use between tree limbs;

FIG. 6 is a cross sectional view taken along line 6-6 in FIG. 3A;

FIG. 7 is a side elevational view of the expandable treestand;

FIG. 8 is a cross sectional view of the expandable treestand taken along line 8-8 in FIG. 3A; and

FIG. 9 is a cross sectional view of the square tube section taken along line 9-9 in FIG. 3A.

### DETAILED DESCRIPTION OF THE PREFERRED EMBODIMENTS

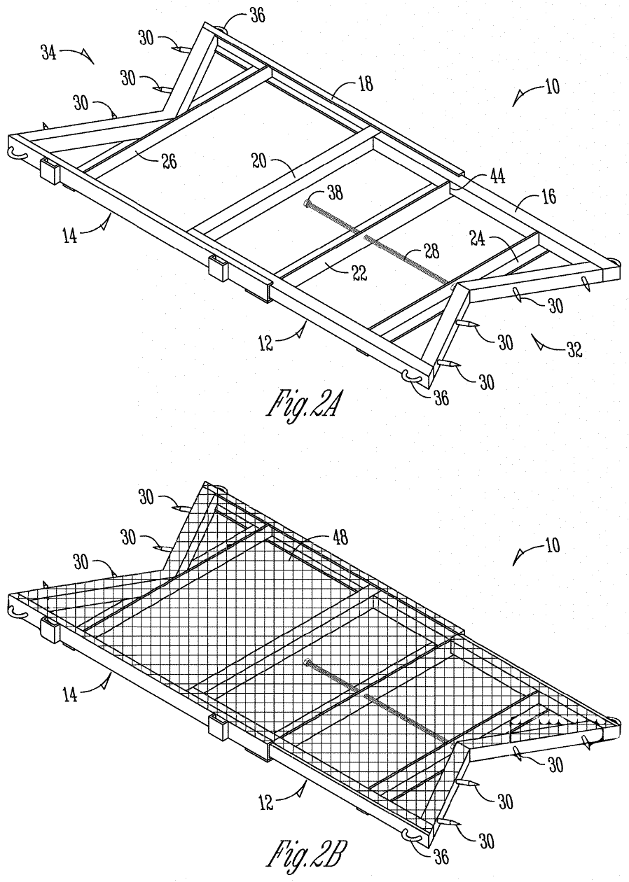

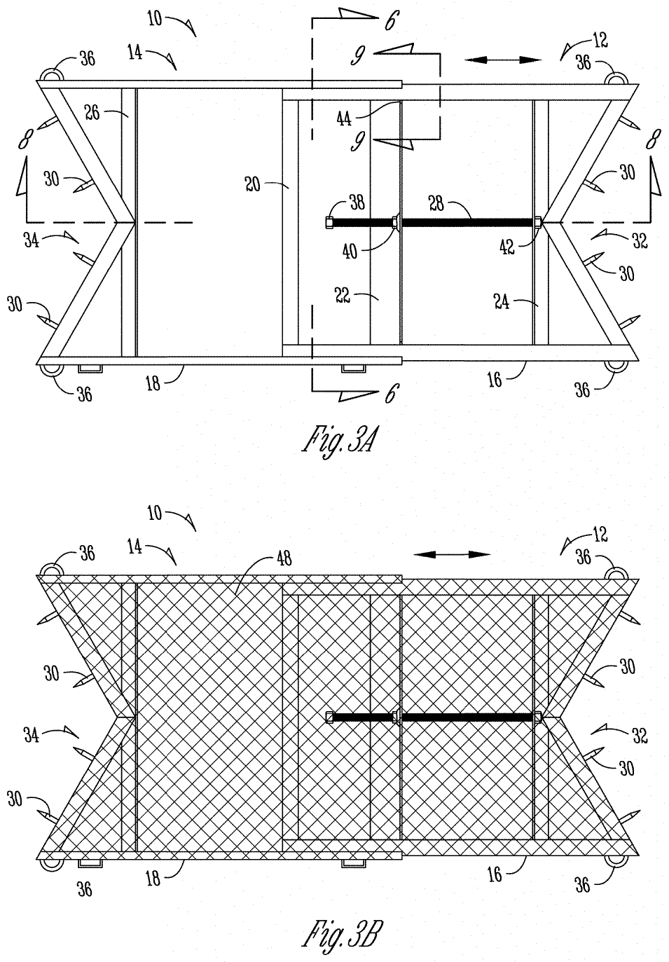

The treestand 10 shown in FIGS. 2A and 3A includes telescopically interconnected frame sections 12 and 14. The frame section 12 includes opposite side sliding square tube members 16 received in u-shaped channel members 18 on frame section 14. Then inner end of the frame section 12 includes a square tube member 20 interconnecting the sliding square tube members 16.

The frame section 12 includes right angle cross members 22 and 24. A right angle cross member 26 is provided on the frame section 14 interconnecting the u-channel members 18 at the outer end of the frame section 14.

The frame sections 12 and 14 are telescopically expanded and contracted by operation of the threaded bolt 28 extending through the threaded nut 40 fixedly attached to the right-angle cross member 22. A nut 42 is fixedly attached to the outer end of the bolt 28 and is free to rotate with the bolt 28. The use of a wrench (not shown) may be used on the nut 38 to rotate the bolt 28 thereby expanding and contracting the frame sections 12 and 14.

As seen in FIG. 9 the right-angle cross member 22 includes slide gaps 44 and 46 to allow the square tube 16 of frame section 12 to move freely within the u-channel 18 of frame section 14.

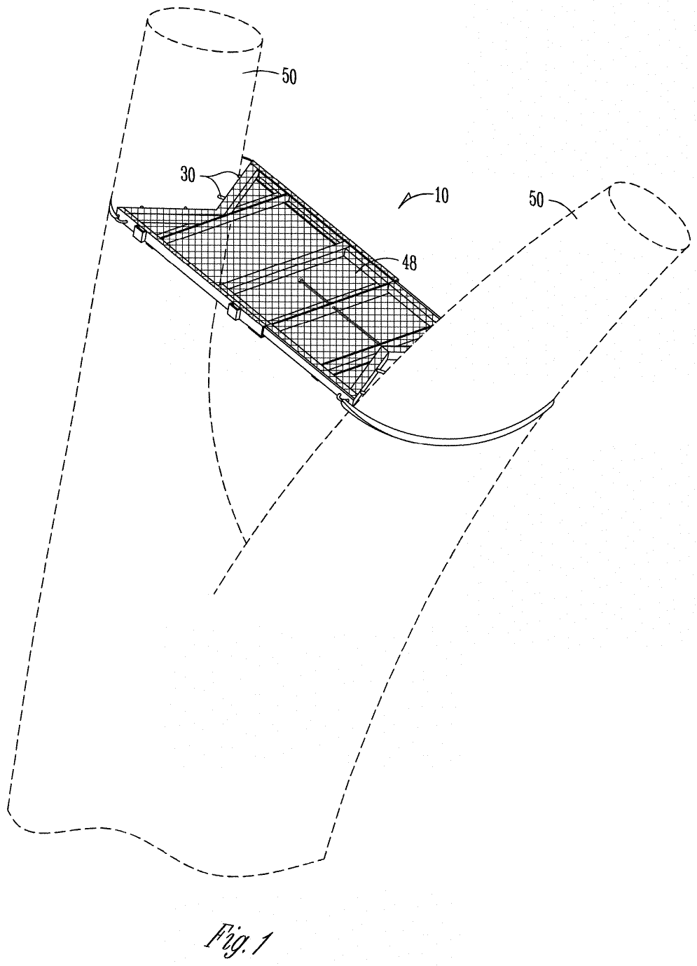

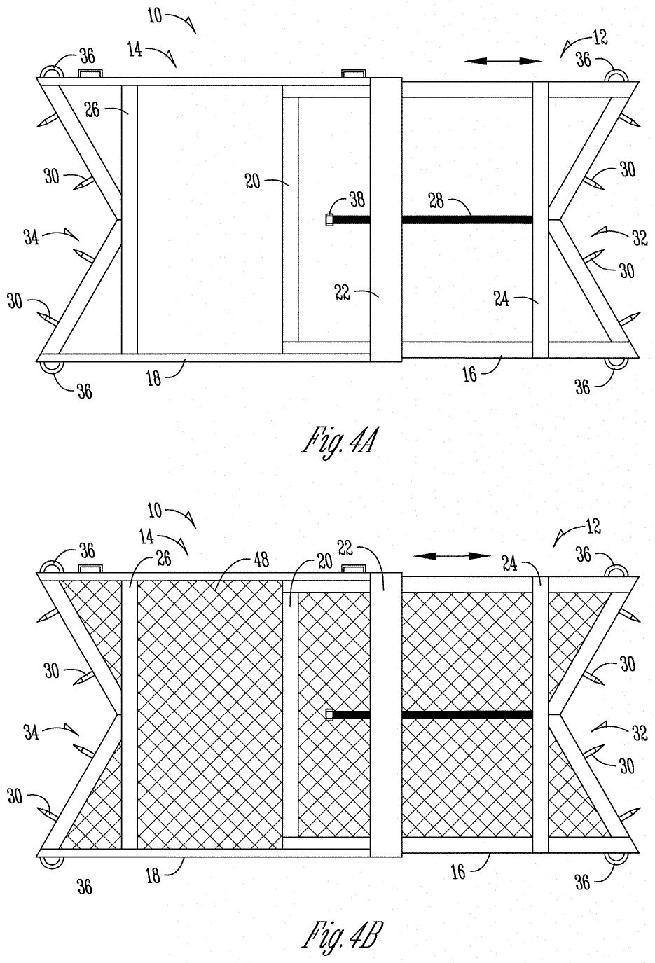

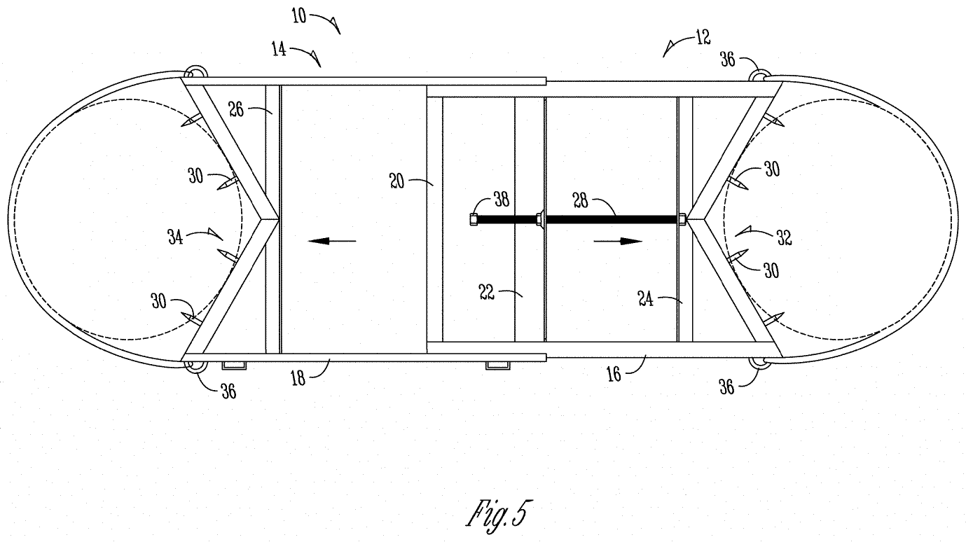

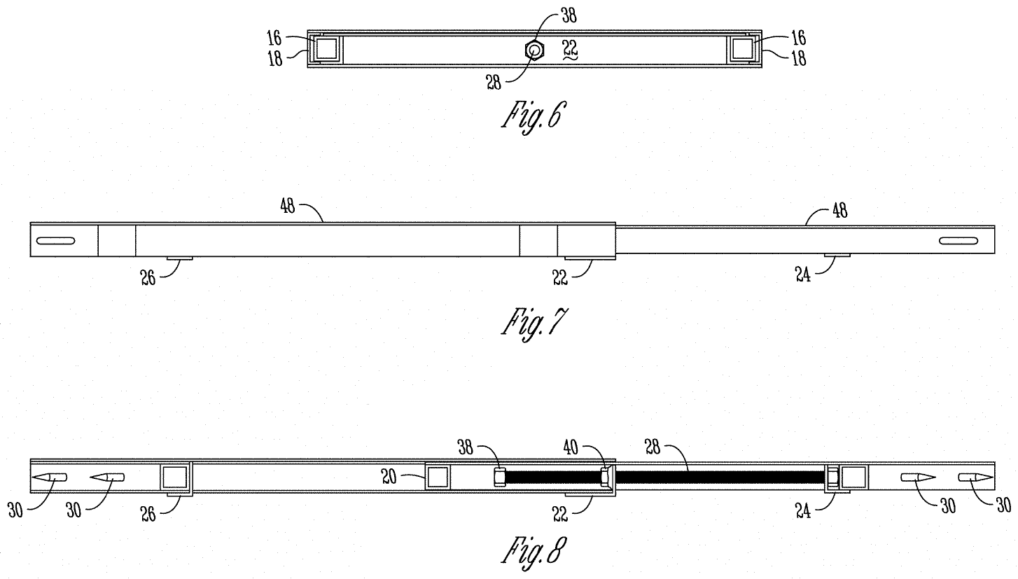

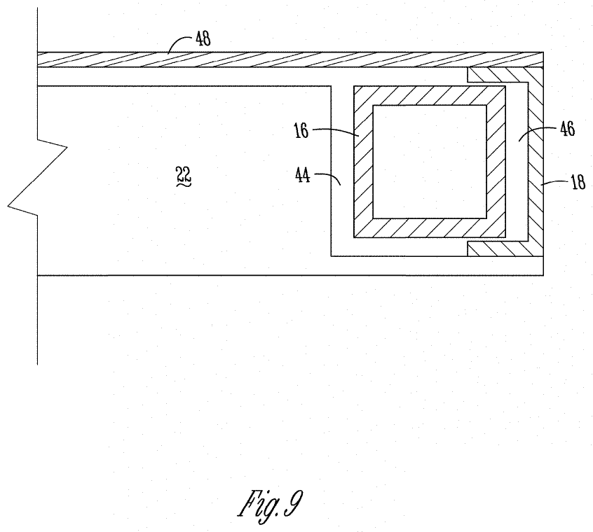

As seen in FIGS. 1, 3B, 4B, and FIG. 9 the top of frame sections 12 and 14 include clover grates 48.

As seen in FIGS. 2A and 3A the outer ends of frame sections 12 and 14 include tree spikes 30 on the v-shaped first angled end tubular member 32 and second angled tubular end member 34.

Strap loops 36 are provided at each of the corners of frame sections 12 and 14.

In use the bolt 28 with a wrench on nut 38 may be operated to extend the treestand 10 to the approximate length appropriate for the spacing between tree limbs where the treestand is to be mounted. The first and second angled tubular ends 32 and 34 will be embracing the tree limbs as seen in FIGS. 1 and 5.

The next step is critical. From below the treestand 10 a wrench engaging the nut 38 will be used to rotate the bolt 28 thereby expanding the frame sections 12 and 14 into the desired tightness of the frame sections engagement with the tree limbs 50. The tree spikes 30 will be buried in the tree limbs 50 absolutely minimizing any risk that the tree stand 10 would ever separate from its mounted. position in the tree.

1. An expandable treestand having an adjustable length, comprising:
first and second telescopically interconnected frame sections, and
a bolt interconnecting said first and second frame sections for expanding and contracting said sections into and out of engagements with spaced-apart tree trunks, said expansion into engagement with said tree trunks being with desired pressure to maintain said stand firmly in engagement with said tree trunks,
said bolt is positioned on the bottom side of said treestand and having a length less than the length of the first and second frame sections,
said bolt being threaded along the length of said bolt to allow for infinite positioning of the first and second frame sections relative to one another,
said bolt has one end fixedly connected to one of said first and second frame sections preventing longitudinal movement of said bolt but permitting rotational movement, and the opposite end from said one end of said bolt being connected to the other of said first and second frame sections to move said first and second frame sections longitudinally relative to each other, and
said connection of the bolt to said other frame section includes a threaded nut fixedly attached to said other frame section allowing said bolt to be rotated for extending and contracting said frame sections.

2. (canceled)

3. (canceled)

4. (canceled)

5. The treestand of claim 1 wherein said bolt is positioned on the bottom side of said first and second frame sections.

6. The treestand of claim 1 wherein the bolt end opposite said one end includes a nut fixedly attached to said bolt adapted for rotation of said bolt when longitudinally expanding and contracting said frame sections.
